(19) United States
(12) Patent Application Publication
(10) Pub. No.: US 2024/0182326 A1
(43) Pub. Date: Jun. 6, 2024

(54) Filter comprising a centring device

(71) Applicant: ACLARIS WATER INNOVATIONS GMBH, LINDAU, ZWEIGNIEDERLASSUNG, Rebstein (CH)

(72) Inventor: Kurt WALLERSTORFER, Strasswalchen (AT)

(21) Appl. No.: 18/551,806

(22) PCT Filed: Mar. 21, 2022
(86) PCT No.: PCT/EP2022/057310

§ 371 Date: Sep. 21, 2023

(30) Foreign Application Priority Data
Mar. 22, 2021 (DE) 10 2021 107 068.6
Sep. 1, 2021 (DE) 20 2021 003 989.9

(51) Int. Cl. C02F 1/00; A47J 31/60

(52) U.S. Cl. CPC C02F 1/003; A47J 31/605; C02F 2201/004; C02F 2201/006; C02F 2307/12

(57) ABSTRACT

A filter cartridge for the use in the interior of a water tank of a domestic appliance having a filter housing of which the wall separates in a watertight manner a housing internal side from a housing external side, wherein a filter inlet opening which in the operating position of the filter cartridge is disposed on the lower end region of the latter and is open in relation to the external environment of the filter housing is provided, wherein provided downstream of the filter inlet opening in terms of the flow direction of water during operation, in the interior of the filter housing, is a device for water conduction which comprises at least one filter chamber having at least one filter medium and terminates in a filter outlet line for suctioning water from the filter cartridge.

### CROSS-REFERENCES TO RELATED APPLICATIONS

This Application is a Section 371 National Stage Application of International Application No. PCT/EP2022/057310, filed Mar. 21, 2022, and published as WO 2022/200255 A1 on Sep. 29, 2022, and claims priority to German Application Nos. 102021107068.6, filed Mar. 22, 2021, and 202021003989.9, filed Sep. 1, 2021. The contents of these applications are hereby incorporated by reference in their entirety.

### BRIEF DESCRIPTION OF THE DRAWINGS

FIG. 1 shows a perspective illustration of a tank bottom having an inserted filter cartridge according to one example.

FIG. 2 shows a perspective exploded illustration of a tank bottom having a centering element and a fastening ring.

FIG. 3 shows a perspective illustration of the tank bottom according to FIG. 2, having an installed centering element and an installed fastening ring.

FIG. 4 shows a view from above onto the tank bottom according to FIGS. 2 and 3;

FIG. 5 shows a perspective illustration of the connection region of the filter cartridge in a lateral view.

FIG. 6 shows a perspective illustration of the connection region of the filter cartridge viewed obliquely from below.

FIG. 7 shows a perspective illustration of a filter cartridge cut open at the height of the filter connector, when inserted into a tank bottom.

FIG. 8 shows a perspective illustration of a filter cartridge cut open at the height of the guide grooves, when inserted into a tank bottom.

FIG. 9 shows a perspective illustration of a filter cartridge when inserted into a tank bottom;

FIG. 10 shows a perspective illustration of the centering element.

FIG. 11 shows a sectional illustration of a tank bottom without a filter cartridge, with the water tank valve opened.

FIGS. 11a and b show two enlarged fragments from FIG. 11 for visualizing a closable bypass line in the tank seal.

FIG. 12 shows a sectional illustration of a tank bottom according to FIG. 11, with an inserted filter cartridge.

FIG. 12a shows an enlarged fragment from FIG. 12 for visualizing the closed bypass line.

FIG. 13 shows a schematic frontal view of a filter connector according to one example.

FIG. 13a shows an enlarged fragment from FIG. 13.

FIG. 14 shows a fragment of the filter cartridge that shows the connection region, for visualizing a guiding aid as a result of bevels of the connector.

FIG. 15 shows a perspective illustration of the centering element having additional axial projections on the centering plinth.

FIG. 16 shows a perspective illustration of respective matching filter cartridge with a guide structure.

### DETAILED DESCRIPTION

The present disclosure relates to a filter cartridge according to the preamble of claim 1.

Filter cartridges are typically used in water-carrying household appliances with a water tank, in particular in beverage machines such as coffee machines, tea machines, etc., in order to improve the water quality in accordance with the intended application. Filter media for water softening, such as ion exchange resin, or to improve the taste, such as activated carbon, are often used in such filter cartridges. The metered addition of additives, e.g. for health or taste improvement, such as the addition of minerals or vitamins, etc., is already provided for in combination with filter media.

Water tanks of machines of this type according to the prior art typically have tank connection structures on the tank bottom with an annular sealing face for the tight connection of a connection element of the filter cartridge provided for such a water tank, which enclose a passage opening in the tank bottom for the water to flow from the filter cartridge and the water tank to the household appliance.

Such water tanks and filter cartridges are described, for example, in publications DE 10 2204 049 877 A1, EP 1 867 606 Al and DE 197 17 054 C2.

In these publications, fixing of the filter cartridge to the tank bottom in various ways is described, e.g. by way of a seal provides with a snap-fit rim, a bayonet closure, or a screw-fit closure.

Screw-fit and bayonet closures have the disadvantage that they superimpose a rotating movement with a linear movement while the connection is being established, this being difficult to accomplish in narrow-shaped water tanks and moreover requiring elastic seals which are able to sustain corresponding loads.

A snap-fit rim does indeed enable simple insertion of the filter cartridge by way of a linear plug-in movement, but is associated with limitations in terms of the shaping of the sealing face.

It is therefore an object of the present disclosure to propose such a filter cartridge and an associated water tank without the afore-mentioned disadvantages.

Proceeding from a filter cartridge according to the preamble of claim 1, this object is achieved by the characterizing features thereof.

In the following, elements to be assigned to the water tank are generally provided with the assigning word beginning “tank” and elements to be assigned to the filter cartridge are provided with the assigning word beginning “filter”. Features of advantageous embodiments and refinements of the present disclosure are described below in such a way that they are not mandatory, but may be present.

The filter cartridge according to one example is provided with a filter housing of which the wall separates in a watertight manner a housing internal side from a housing external side, wherein a filter inlet opening which in the operating position of the filter cartridge is disposed on the lower end region of the latter and is open in relation to the external environment of the filter housing is provided. As a result, the filter cartridge differs from filter devices of which the housing is connected in a tight manner to water lines of a water network by way of pressure-tight connections and in this way incorporated in the water network.

Furthermore, a filter cartridge according to one example, downstream of the filter inlet opening in terms of the flow direction during operation, in the interior of the filter housing, has a device for water conduction which comprises at least one filter chamber having at least one filter medium and terminates in a filter outlet line for suctioning water from the filter cartridge. Furthermore provided is an annular filter connection for connecting the filter cartridge in a water tank.

Proceeding from a filter cartridge of this type and a water tank of this type according to the preamble of claims 1 and 11, the above-mentioned object is achieved by the characterizing features of said claims.

Provided accordingly in a filter cartridge according to one example within the filter sealing face of the filter connection is a filter-proximal guide structure for receiving a tank-proximal centering element for fixing the filter cartridge. The positioning and the fixing can thus be easily accomplished by a centering element projecting from the tank bottom. Since the sealing face per se can be designed independently of a centering element of this type, there is greater freedom in terms of construction both with a view to the design of the sealing face or the seal, as well as of the centering element.

A filter-proximal guide structure for receiving the centering element when inserting the filter cartridge into the water tank can, for example, form a portion of an outlet line of the filter cartridge, which in terms of the flow during operation is disposed downstream after the end of the filter section. A space-saving embodiment results from this dual function of the filter-proximal guide structure, the latter besides fixing also serving for conducting water.

A further portion of the outlet line, hereunder referred to as the inner portion, can be provided between that portion of the outlet line that has the guide structure and the end of the filter section, which inner portion connects the portion of the outlet line that has the guide structure to the filter section. The portion of the outlet line that has the guide structure can have a larger cross section than an inner portion of the outlet line that lies upstream thereof.

A connector that has the filter sealing face and in terms of the flow during operation lies downstream of the guide structure, can in turn have a larger cross section than the guide structure and comprise an exit portion of the outlet line. In this instance, the guide structure represents a transition portion of the outlet line between the inner portion and the exit portion.

In particular embodiments, the filter-proximal guide structure in the transition portion has one or a plurality of obliquely disposed transition faces which are oblique in relation to the assembling direction of the filter cartridge. Such obliquely disposed transition faces are suitable for facilitating the positioning of the filter cartridge while receiving a tank-proximal centering element during assembly.

The mentioned portions of the outlet line are preferably disposed so as to be coaxial with a central axis (A) of the outlet line. The one or the plurality of oblique transition faces, in a profile directed radially from the outside to the inside and axially from top to bottom in terms of the operating position of the filter cartridge, can connect the transition portion to the inner portion of the outlet line.

The transition faces preferably form a detent face so that the guide structure, when being attached, in the terminal position can impact on a correspondingly configured tank-proximal centering element by way of one of a plurality of oblique guide faces.

The filter-proximal guide structure can be configured and disposed so as to be coaxial with the filter sealing face surrounding the guide structure. This centrical disposal enables the uniform distribution of the open flow cross section for the water by way of the filter-proximal guide structure.

Furthermore, the filter-proximal guide structure can have one or a plurality of guide faces which run parallel to a central axis A.

As already mentioned, the tank-proximal centering element preferably has one or a plurality of oblique guide faces. When attaching the guide structure to a tank-proximal centering element, a tank-proximal centering element can first be centered on the oblique guide face or guide faces of the tank-proximal centering element, and by means of the axially parallel guide face or guide faces subsequently be further axially displaced so as to be centrally aligned on said tank-proximal centering element, for example so as to establish a sealing and/or fixing form-fit with a sealing and/or fixing face. Depending on the embodiment, one or a plurality of tank-proximal guide faces may or may not impact on one or a plurality of filter-proximal transition faces in the process.

Moreover, holding or latching elements are advantageously affixed in the filter-proximal guide structure. As a result, embodiments are possible which are held entirely or partially on the inside, so that external fixing means can be dispensed with or at least reduced.

The exit portion of the outlet line advantageously has a larger cross section than the transition portion of the outlet line that has the guide structure. The transition portion by way of a connection wall that runs transversely to the central axis (A) can be connected to the exit portion. This connection wall can furthermore have axial depressions and/or axial projections.

In this connection wall, the axial depressions and/or axial projections can be disposed in the region of radial convexities of the filter sealing face.

As a result of the angular alignment of the guide structure, e.g. as a result of the angular alignment of guide grooves or guide edges of the guide structure in relation to these axial depressions and/or projections, a mechanical coding or key/lock function can be generated in order to ensure that only a filter cartridge suitable for the respective application can be used.

Moreover, the axial depressions and/or axial projections can have an elongate shape with an angular alignment in relation to a radius emanating from the central axis, as a result of which this angular alignment can also assume an additional function.

In this way, the axial depressions and/or axial projections, owing to their position and/or angular alignment, can form elements for additional coding of the filter cartridge.

Moreover, a receptacle for a plug element of a tank valve, which penetrates the tank-proximal centering element, is advantageously provided in the filter-proximal guide structure. Such a plug element has to be accommodated so as to be movable in the guide structure of the filter cartridge and must not be jammed when assembling the filter cartridge, as the functioning of the tank valve would otherwise be prevented. In this way, such a plug element represents an additional coding in order to prevent the use of an unsuitable filter cartridge.

It is furthermore advantageous for the tank-proximal centering element and the tank valve to be mutually adapted in such a way that coding between the tank valve and the centering element results. A tank having a tank valve of such a design can thus be operated only in conjunction with a matching centering element. In one particular embodiment, the plug element of the tank valve engages in a passage of the centering element.

The guide structure of the filter cartridge can have one or a plurality of guide grooves for receiving tank-proximal structures. This results in a type of tongue-and-groove structure during the centering and fixing of the filter, so that the angular position of the filter cartridge is also fixed. Moreover, this results in further coding possibilities.

The one or the plurality of oblique transition faces of the filter-proximal guide structure can be affixed in one or a plurality of guide grooves for receiving tank-proximal structures.

A water tank for a domestic appliance that matches the above-described filter cartridge is provided with a tank bottom, as mentioned at the outset, wherein an annular tank sealing face, which encloses a tank passage opening for the flow of water from the filter cartridge through the wall of the tank bottom to the domestic appliance, for tightly connecting the filter cartridge is provided on the tank bottom. Furthermore provided is a centering element, which within the tank sealing face projects from the tank bottom in the direction of the assembled position of the filter cartridge, for plugging into the filter-proximal guide structure of the filter cartridge.

At least one water passage for water from the filter cartridge through the guide structure of an attached filter cartridge to the tank passage opening can be provided on the centering element. As a result, the centering element can at least partially bear on the internal wall of the filter-proximal guide structure, without impeding the water flow.

The tank sealing face is advantageously configured and disposed separately from the centering element, as a result of which these two elements can be designed in a largely independent manner and do not influence one another.

One possibility of providing one or a plurality of flow openings for the water lies in that, for example, the centering element comprises ribs which extend in the flow direction of the water during operation, the intermediate space of said guide ribs forming a water passage. The ribs in this instance, in a guiding function, as guide ribs can externally bear in the radial direction on the filter-proximal guide structure.

The centering element can have, for example, a centering plinth from which the guide ribs can extend upward in terms of the operating position of the water tank, said centering plinth externally having a circumferential external face which may optionally also form a tank sealing face.

Axial projections and/or axial depressions for attaching or inserting the axial depressions and/or axial projections of the filter cartridge can be affixed in the centering plinth.

The axial projections and/or axial depressions on the centering plinth can expediently be disposed in the region of the radial convexities of the external face of the centering plinth.

As a result of the angular alignment of these axial projections and/or axial depressions on the centering plinth in relation to the centering element, in particular in relation to the centering plinth or ribs affixed thereto, the coding or key/lock function that matches an above-mentioned guide structure with corresponding axial depressions and/or axial projections can be established. This angular relationship can be fixedly established to be permanent when shaping the respective axial projections and/or axial depressions, or else be provided to be adjustable by way of one or a plurality of adjustable ancillary elements which support respective axial projections and/or axial depressions.

The axial projections and/or axial depressions on the centering plinth can moreover have an elongate shape with an angular alignment in relation to a radius emanating from the central axis, as a result of which this angular alignment can also assume an additional function.

In this way, the axial depressions and/or axial projections of the centering element, owing to their position and/or angular alignment matching the guide structure of the filter cartridge, can form elements for additional coding by way of the guide structure of the filter cartridge, for example.

If the centering element is configured with ribs disposed in a star-shaped manner, this results in a uniform distribution of the open flow cross section for the water, and at the same time in circumferentially uniform contacting and thus fixing of the filter-proximal guide structure of the filter cartridge.

At least one, preferably a plurality of, or all ribs of the centering element are provided with an upper oblique guide face for guiding the filter-proximal guide structure when assembling the filter cartridge. This oblique guide face, or these oblique guide faces, can then interact with the corresponding oblique transition face(s) of the guide structure of the filter cartridge. Moreover, at least one guide face of the centering element, which runs parallel to the central axis, for guiding the filter cartridge in an axially aligned manner after centering, during further attaching and/or inserting, can be provided.

Furthermore, holding or latching elements which are adapted to corresponding holding or latching elements of the guide structure of the filter cartridge can be affixed to the centering element.

It is furthermore advantageous for the centering element to be affixed to a fastening ring for fastening to the tank bottom. In this way, different fastening rings with specific centering elements can be used for water tanks of identical configuration, which are thus specified for different domestic appliances such a beverage machines, etc.

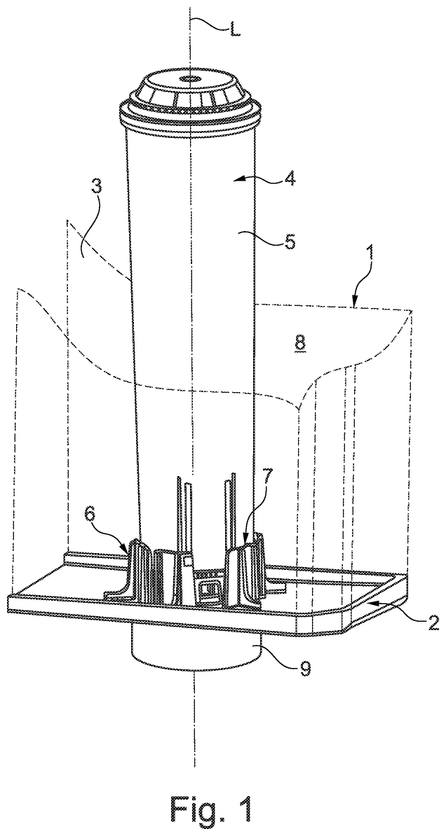

FIG. 1 visualizes the usual design embodiment of a water tank 1 of a beverage machine such as a coffee machine, e.g. of a fully automatic coffee machine according to the prior art. The water tank 1 comprises a tank bottom 2 and water tank side walls 3 which are partially illustrated using dashed lines. A filter cartridge 4 having a filter housing 5 is inserted in the water tank 1. The connection between the tank bottom 2 and the filter cartridge 4 is implemented by tank connection elements 6 on the water tank and by filter-proximal filter connection elements 7.

The filter cartridge 4 is situated in the interior 8 of the water tank 1, i.e. during operation is entirely or partially in the water stored in the water tank 1. A filter connector 9 of the water tank 1 for connecting the water tank 1 to the beverage machine not illustrated projects from the lower side of the water tank 1.

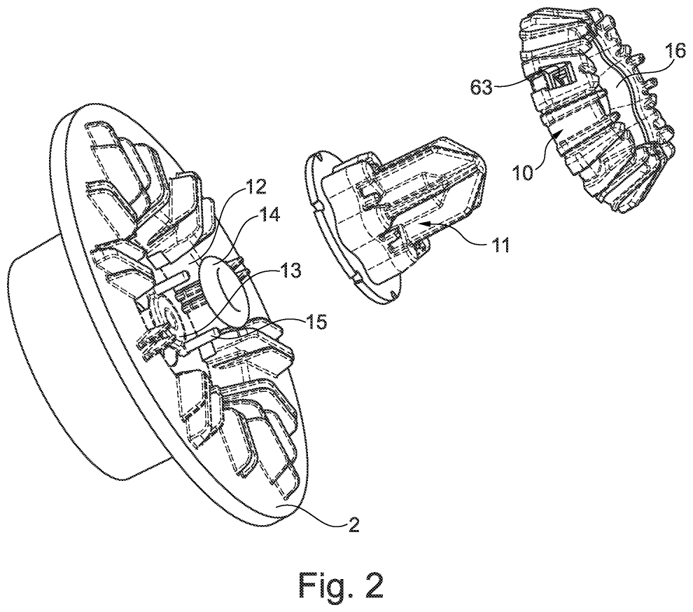

Illustrated in FIG. 2 is a round fragment of the tank bottom 2, wherein provided are a fastening ring 10 and a centering element 11 for placing in a depression 12 of the tank bottom 2. Likewise to be seen in FIG. 2 is a tank valve body 13 having a seal 14 which is configured as an O-ring, two pins 15 projecting upward from said tank valve body 13. The fastening ring 10 furthermore supports an elastomer seal 16.

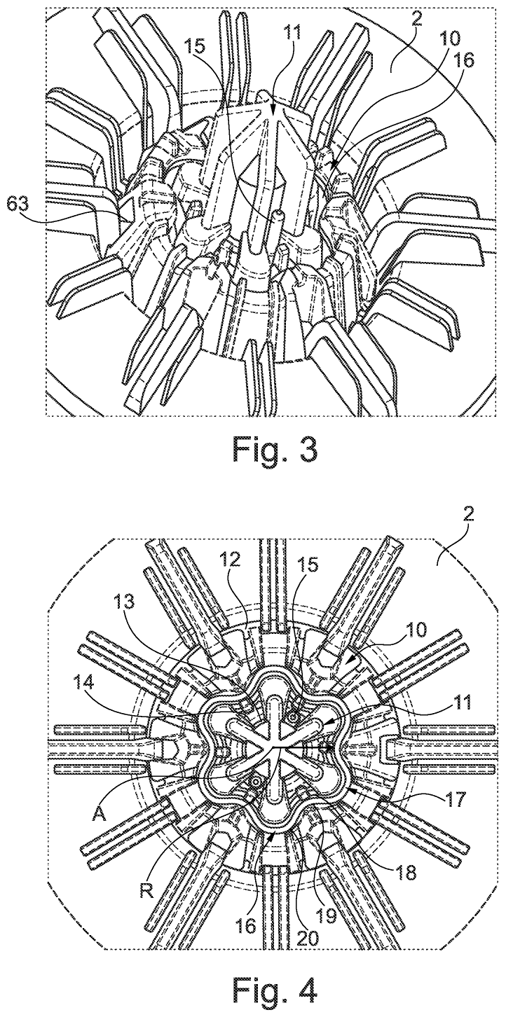

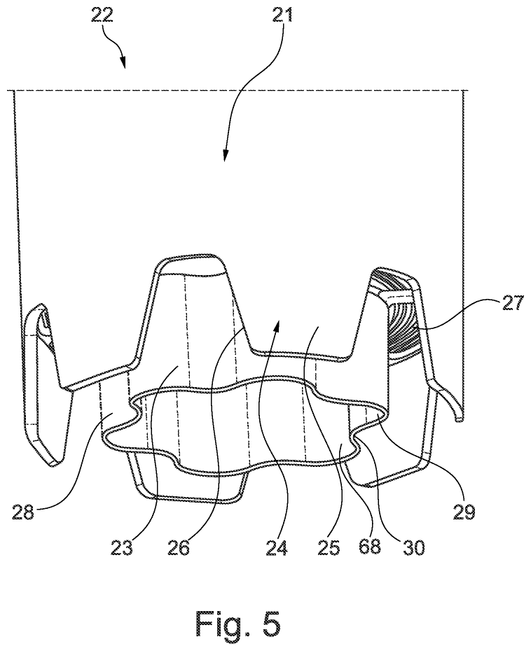

The fastening ring 10 and the centering element 11 in FIGS. 3 and 4 are installed in the tank bottom 2. It can be seen here that the pins 15 penetrate the centering element and in this way from coding elements for coding the water tank in relation to the associated machine connection, the latter having to activate the tank valve body 13 when the water tank is being inserted.

Furthermore, it can be readily seen in FIG. 4 that the elastomer seal 14, which forms the water tank seal 17, is an annular seal which along the circumference thereof has a radius R which varies in relation to a central axis A, so that the internal face of the water tank seal 17 that forms a tank sealing face 18 comprises radial concavities 19 and radial convexities 20. The first tank sealing face 18 simultaneously serves as the first tank fixing face.

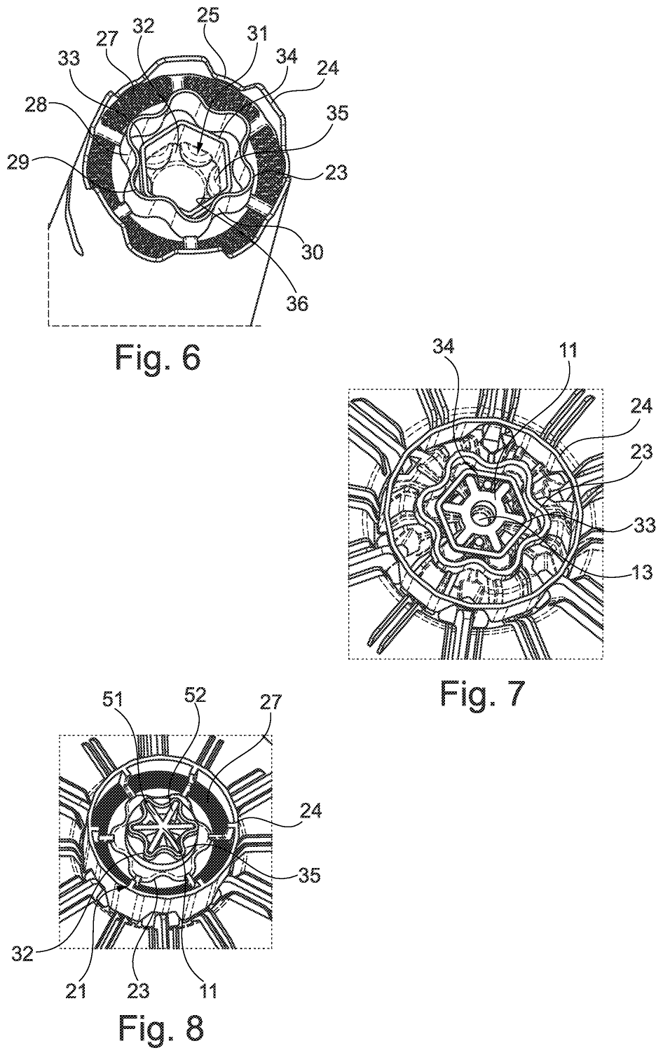

Shown in FIG. 5 is the connection region 21 of a matching filter cartridge 22. A filter connector 23 forms an inner ring which is surrounded by an outer ring 24 having axially running projections 25 and recesses 26. An annular inlet screen 27, through which water makes its way into the filter cartridge, is situated between the inner ring 23 and the outer ring 24. The external face 28 and the internal face 68 of the filter connector 23 are likewise provided with convexities 29 and concavities 30, so as to match the tank sealing face 18.

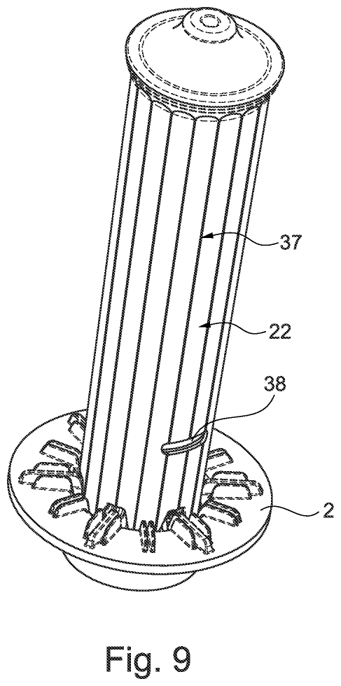

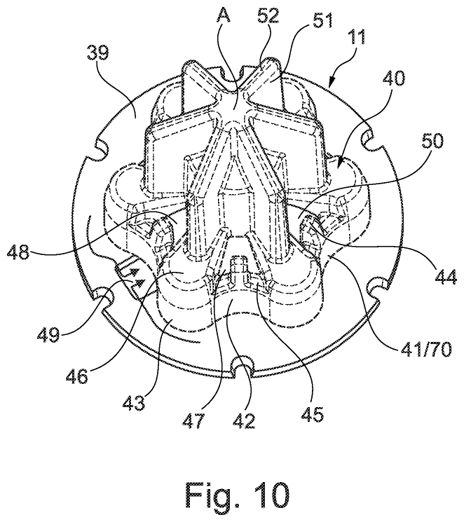

Besides the above-described parts of the connection region 21 of the filter cartridge 22, the particular design embodiment of a guide structure 31 of the filter cartridge 22 for receiving the centering element 11 is illustrated in FIG. 6. The guide structure bas guide grooves 32 which are co-aligned with the edges 33 of a polygonal ring 34, presently in an exemplary manner with six guide grooves being co-aligned with six edges of a hexagonal ring. In the section illustration viewed from above in FIG. 7, the section plane runs through this polygonal ring 34.

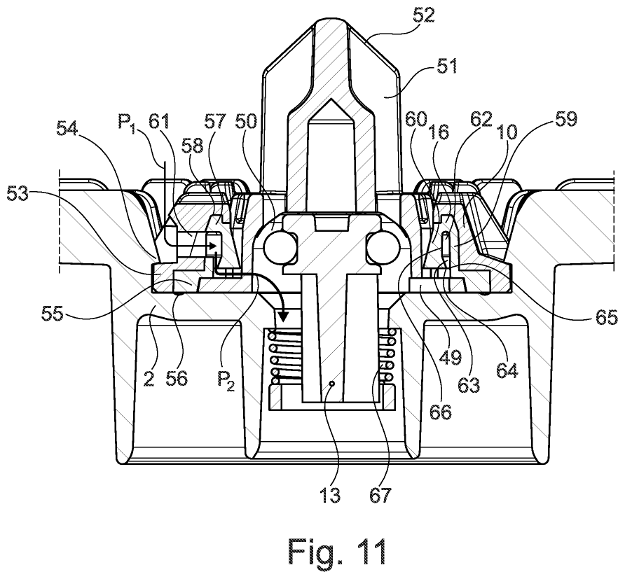

Internal curvatures 34, which lie between the edges 33 and the guide grooves 32, adjoin upward into the interior of the filter cartridge. The internal curvatures 35 form the lateral walls 36 of the guide grooves 32. As a result of the curved shape, the walls 36 of the guide grooves 32 taper both in the axial direction upward (in terms of the operating position) and in the radial direction from the inside to the outside. At the interface, when viewed from above according to FIG. 8, the section plane runs at a height at which the guide grooves 32 are clearly configured. A standpipe 37 through which the water entering the filter cartridge 22 is directed upward to the filter section adjoins on the inside, so as to be central.

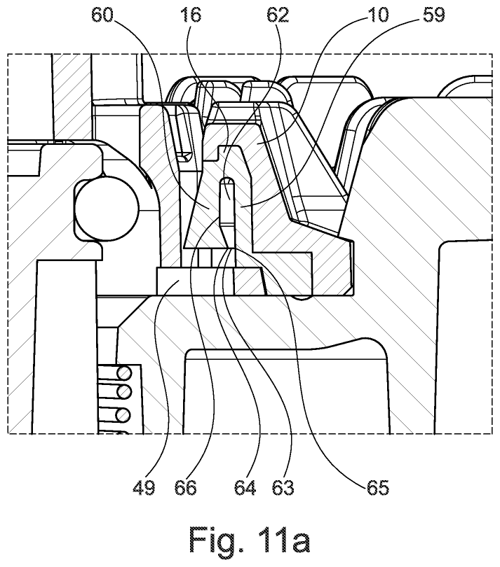

The entire filter cartridge 22 is illustrated in FIG. 9. In a filter housing 37 which has an optional lateral metering opening 38 and the described bottom-proximal water connection. The optional metering opening 38 is provided only in the case of an embodiment of the filter cartridge configured for dispensing supplements, e.g. minerals, vitamins or the like, from a metering chamber accommodated in the filter housing 37 into the stored water. Since such a metering chamber within the filter housing 37 is closed in relation to the filter section, the former has no further relevance in terms of filtration. A filter cartridge according to one example can thus be readily configured without this metering chamber and the metering opening 38 of the latter. To be seen in particular in FIG. 9 is the operating position to which the indications top and bottom refer to in this description.

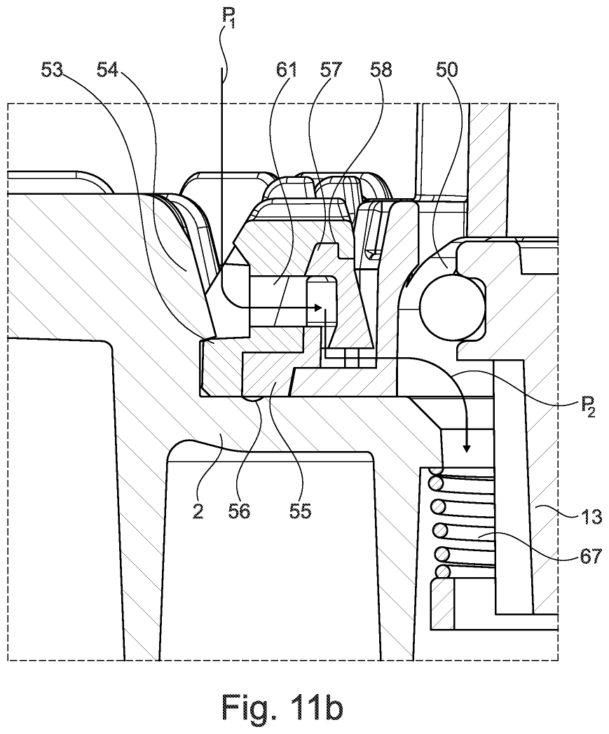

A perspective illustration of the centering element 11 can be seen in FIG. 10. The centering element is provided with a bottom plate 39 which in the assembled state, when lying in a receptacle of the elastomer seal, peripherally engages the latter from the rear. A centering plinth 40, which has an annular external face 41 which also forms a second tank fixing face, projects upward from the bottom plate 39. This external face 41 has a radius that along the circumference varies in relation to the central axis A, so that this external face 41 also comprises radial concavities 42 and convexities 43. In this way, the external face 41 is adapted to a corresponding shape of the filter connector 9.

For further adaptation, the concavities 42 and convexities 43 of this external face 21 are also configured so as to periodically oscillate about a circular line and have a round profile. In the embodiment illustrated, six concavities 42 and six convexities 43 are provided along a circular line with a diameter of less than 3 cm, corresponding to the design of the illustrated embodiment of the filer cartridge 22. In another filter cartridge, the adaptation of the external face 41, or of the second tank fixing face, respectively, is to be modified in a corresponding matching manner.

All adaptations of the external face 41 of the centering plinth 11 lead to only one annular slot between the external face 41 and the elastomer seal 16 being open for introducing the filter connector 9 in the installed state. This results in a further coding in relation to the use of an unsuitable filter cartridge. Moreover, in this way it is possible for the filter connector 23 on the internal side thereof to be supported on the external face 41 of the centering plinth 11. In this way, the contact pressure of the filter connector on the elastomer seal 16 can be uniformly increased by way of the varying shape along the entire circumferential shape.

Provided above the annular external face is at least one upwardly projecting tooth 44. The one tooth or the plurality of teeth are affixed to a gradation 45 of the centering plinth 40. Further elevations 46 in relation to the gradation 45, which follow the shape of the external face 41, are affixed at a spacing from the teeth 44 so that a gap 47 remains between the teeth and the elevations 46. The tooth or the teeth 47 and/or the elevations 46 can prevent the use of an axial seal for circumventing the coding. Furthermore provided above the external face 41 is a passage opening 58 which in the assembled state of the centering element 11 leads to a tank passage opening. The filtered water of a filter cartridge 22 can be discharged from the water tank by way of this passage opening 48.

One or a plurality of bottom passage openings 49 are provided in the bottom plate 39, below the external face 41. Unfiltered water from the water tank can be directed through these bottom openings. A cavity 50 for receiving the tank valve body 13 results below the elevations 46 and within the wall supporting the external face 41.

Provided above the annular external face 41 are guide ribs 51 which on the upper side thereof can be beveled, as in the exemplary embodiment illustrated. The guide ramps 52 formed in this way assist when introducing the guide ribs 51 into the guide grooves 32 of a filter cartridge 22. In the sectional illustration according to FIG. 4, the guide ramps 52 of the guide ribs 51 can be readily seen in the attached filter cartridge 22.

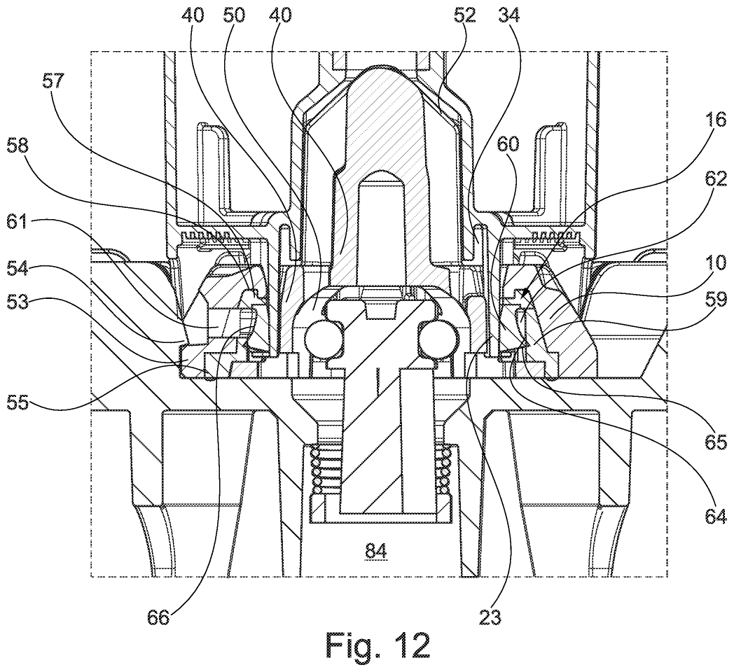

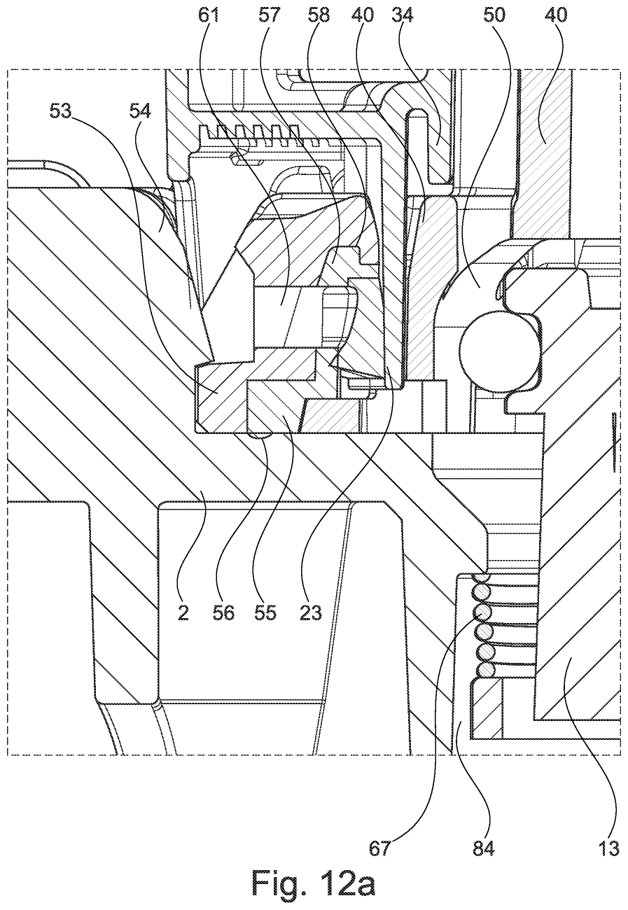

The assembled components of the water tank 1 for the connection of a filter cartridge with and without a filter cartridge 22 are shown in FIGS. 11, 11a, 11b, 12 and 12a. The fastening ring 10 is provided with a latching projection 53 with which it can latch on the tank bottom 2 by engaging behind a bottom rib 54 of the water tank. The elastomer seal 16 has a bottom section 55 which engages under the fastening ring 10 and thus holds the elastomer seal 16 with the fastening ring 10 on the tank bottom 2.

For sealing in relation to the tank bottom 2, the elastomer seal 16 has a sealing face, which in the present case is realized by a sealing bead 56. For the tight closure of the elastomer seal 16 in relation to the fastening ring 10, a circumferential sealing face can be provided at various points. In the exemplary embodiment shown, an annular seal 57 is provided which is formed on top of the elastomer seal 16 and seals with the latter in a sealing groove 58 of the fastening ring.

The elastomer seal 16 includes an outer ring 59 and an inner ring 60 which are integrally molded and connected to each other. The outer ring 59 and the inner ring 60 in terms of the shape thereof both follow circumferentially the variable radius of fastening ring 10, of the filter connector 23 and of the elastomer seal 16 and the concavities and convexities formed thereby. The outer ring 59 is stepped and carries the annular seal 57 and the sealing bead 56. The outer ring 59 is also provided with one or more bypass openings 61 through which unfiltered water can enter the annular gap 62 between the outer ring 59 and the inner ring 60 in the direction of flow PI. In the installed state, the bypass opening 61 of the elastomer seal 16 is located directly after a bypass opening 63 in the fastening ring 11, which can also be seen in FIGS. 1 and 3, for example. Through the bypass opening 63, unfiltered water can flow out of the annular gap 62 from the water tank 1 in the direction P2 into the corresponding beverage machine.

The inner ring 60 has a sealing lip 64 on its lower side, which is opposite a sealing face 65 on the outer ring 59. In the relaxed state of the elastomer seal 16, the annular gap 62 between the outer ring 59 and the inner ring 60 is open at the bottom, as can be seen in FIG. 11, so that the unfiltered water guided in the bypass can flow out of the annular gap 62 in flow direction P2. In this state, the internal side 66 of the inner ring 60, which forms the water tank seal 17, in the downward profile is beveled inward. The design embodiment of the bypass is highlighted in the enlargements according to FIGS. 11a and b.

When a filter cartridge 22 with the filter connector 23 is inserted, the elastomer seal 16 is deformed so that the internal side 66 is pressed outward and runs essentially perpendicularly along the filter connector. The sealing lip 64 is pressed onto the opposite sealing face 65, and thus the annular gap 62 and thus also the bypass through the bypass openings 61, 63 are closed. The deformation generates a contact pressure that presses the tank sealing face 17 against the filter sealing face 28 and at the same time the sealing lip 64 against the sealing face 65. This state is shown in FIG. 12 and FIG. 12a.

The tank valve body 13 in FIG. 11 and in FIG. 12, by a detent (not shown in more detail) of the associated machine is raised counter to a restoring spring 67 into the cavity 50 and is thus in the open position which corresponds to the inserted water tank. If the water tank is removed from the machine, the tank valve body 13 closes under the pressure of the restoring spring 67.

The tank sealing face 18 is formed by the internal side 66 of the elastomer seal 16 and at the same time represents a first tank fixing face 18. As mentioned above, a first filter fixing face 28 formed by the filter sealing face 28 rests on this side when the filter cartridge 5, 22 is in the inserted state, under a contact pressure that deforms the elastomer seal 16 in such a way that a fixing and sealing form-fit is achieved.

A second filter fixing face 68 (see FIG. 5), which is formed by the internal face of the filter connector 23, is in contact with the external face 41 forming the second tank fixing face. This form-fit is also formed under a contact pressure. Due to the shape of the filter connector 23 according to one example, this forms an annular wall 69 which can be widened in a resilient manner if necessary. This results in the possibility of tolerance compensation with good fixing, which is caused by the corresponding bracing. Due to the mutually parallel or mutually inclined shaping of the first filter fixing face 28 and a second filter fixing face 68, the annular, corrugated wall 69 of the connector 23 lying between them forms a corrugated annular spring 70. The second filter fixing face 68 can also act as a second filter sealing face.

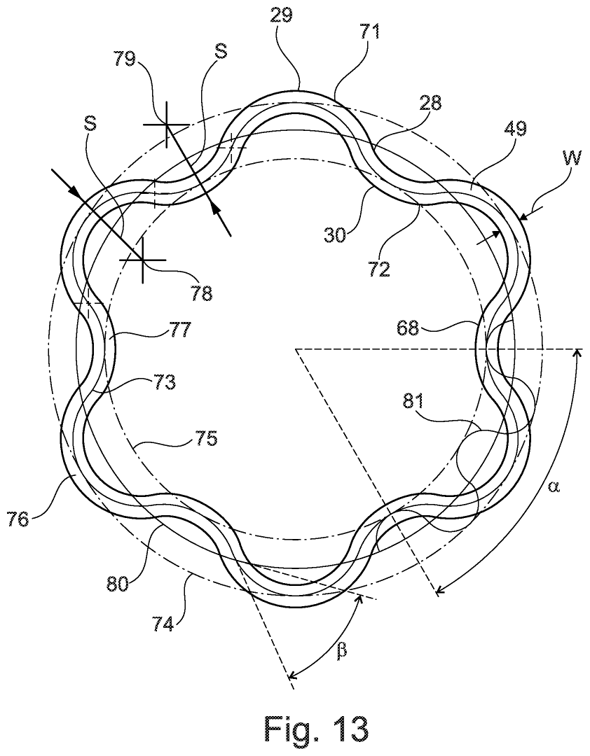

The filter connector according to the end view in FIG. 13 and the enlarged detail according to FIG. 13a shows the wave shape described with convexities 29 and concavities 30. The annular wall 69 of the filter connector 23 with a wall thickness W has the first filter fixing face 28 on the wall external side 71 and the second filter fixing face 68 on the wall internal side 72. The wall external side 71 and the wall internal side 72 run parallel in the view shown, but are beveled toward one another in the axial direction, which will be explained further below. The wave shape is therefore further illustrated by means of a center line 73 shown in broken lines.

The center line 73 undulates between an outer envelope circle 74, whose radius has the largest value of the variable radius, and an inner envelope circle 75, whose radius has the smallest radius of the variable radius of the wave shape. The convexities 29 and concavities 30 of the center line 73 form wave crests in the form of convex circle segments 76 and wave troughs in the form of concave circle segments 77. In the illustrated embodiment, all circle segments 76, 77 have the same segment radius S. The centers 78, 79 of the circle segments 76, 77 lie within the inner envelope circle 75 for the convex circle segments 76 and outside of the outer envelope circle 74 for the concave circle segments 77. The convex circle segments 76 and the concave circle segments 77 merge tangentially and are evenly distributed over the circumference, resulting in a rotationally symmetrical shape. In the exemplary embodiment shown, in each case six convex circle segments 76 and six concave circle segments 77 are provided, which alternately lie at an angular distance of 30°, i.e. the convex circle segments 76 lie at an angle α of 60° apart from one another and the same applies to the concave circle segments 77.

Due to the selection of the segment radius and the associated position of the associated centers 78, 79, the center line runs in a comparatively flat, curved, wavy manner around the center circle line 80. The center line 73 intersects the center circle line 80 at an obtuse angle β. As a result, the arc length of the convexities 29 is significantly longer than the arc length of the concavities 30, as a result of which the angle γ swept by the segment arc of the convexities 29 is significantly larger than the angle δ swept by the concavities 30. This shape improves the spring effect of the filter connector 23.

For comparison, the drawing also shows circle segments 81 whose segment centers 82 lie directly on the center line 73. This profile, which is not realized in this embodiment, has significantly smaller segment radii and a profile that is essentially perpendicular to the center line 73.

A good spring effect has been shown with radii and wall thicknesses in which the radius of the inner envelope circle 75 is between 5% and 15% of the radius of the outer envelope circle 74 and the radius of the convex and/or concave circle segments is between 20% and 35% of the radius of the outer envelope circle 74. The wall thickness W between the wall external side 71 and the wall internal side 72 running parallel or inclined thereto (relative to the operating position) is preferably between 5% and 15% of the radius of the outer envelope circle 74.

In the example shown, the outer envelope circle 74 has a radius of approximately 11 mm and the inner envelope circle 75 has a radius of approximately 9.75 mm. The segment radius of the convex and concave circle segments is approx. 3.08 mm and the wall thickness between the wall external side 71 and the wall internal side 72 running parallel or inclined thereto is approx. 0.9 mm.

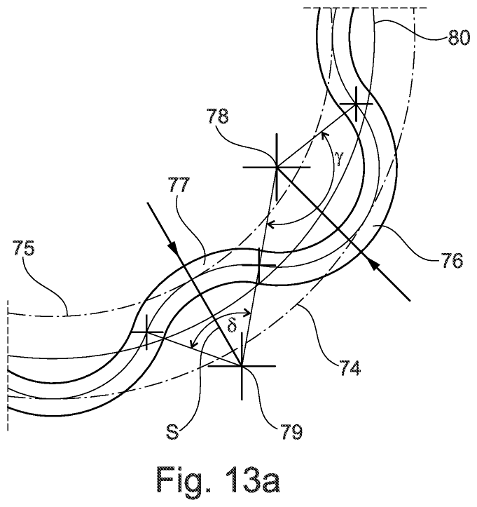

In FIG. 14 it can be seen that the external 71 - and/or the internal wall 72 of the filter connector 23, which depending on the embodiment also form one or two filter sealing faces 28, are beveled by the angle ω1 or ω2 in relation to the vertical, so that they based on the operating position of the filter cartridge 4, 22 converge from top to bottom. This bevel or bevels by the angle or angles ω1 and/or ω2 form an insertion aid when inserting the connector 23 into the annular gap between the elastomer seal 16 and the external face 41 of the water tank 1.

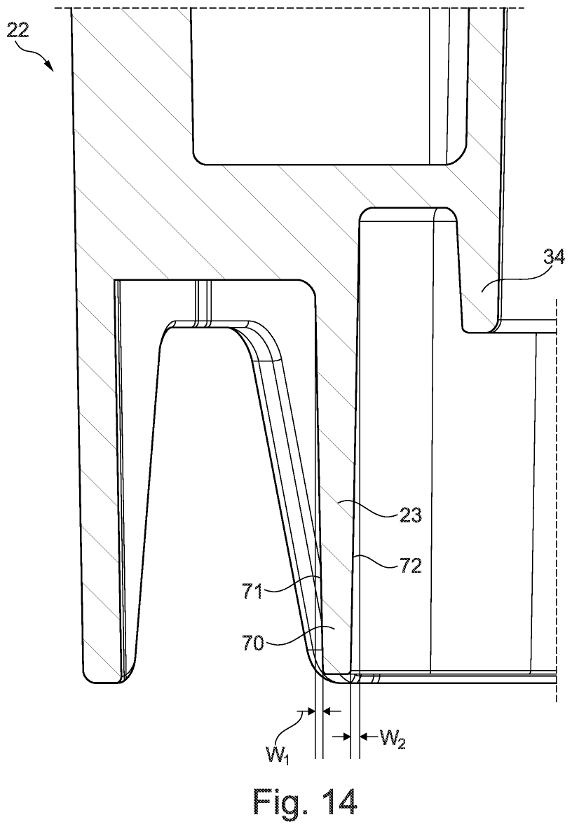

FIG. 15 shows a centering element 11 which is fixed to the tank bottom 2 by a fastening ring 10. The centering plinth 40 in this exemplary embodiment is provided with axial projections 85 which by way of an angle [symbol] are in an angular relations ship with the guide ribs 51. By twisting the assembly of the axial projections 85 in relation to the guide ribs 51, as indicated by the double arrow V, a coding for a key/lock function can therefore be generated.

The axial projections on the centering plinth 11 are in the region of the radial convexities 43 of the external face 41, where there is sufficient space on the centering plinth of this embodiment.

In the embodiment illustrated, the axial projections 85 have an elongate shape so that an additional function, for example a coding function, is able to be implemented as a result of the angular orientation of said axial projections 85 at the angle δ in relation to a radius R emanating from the central axis A.

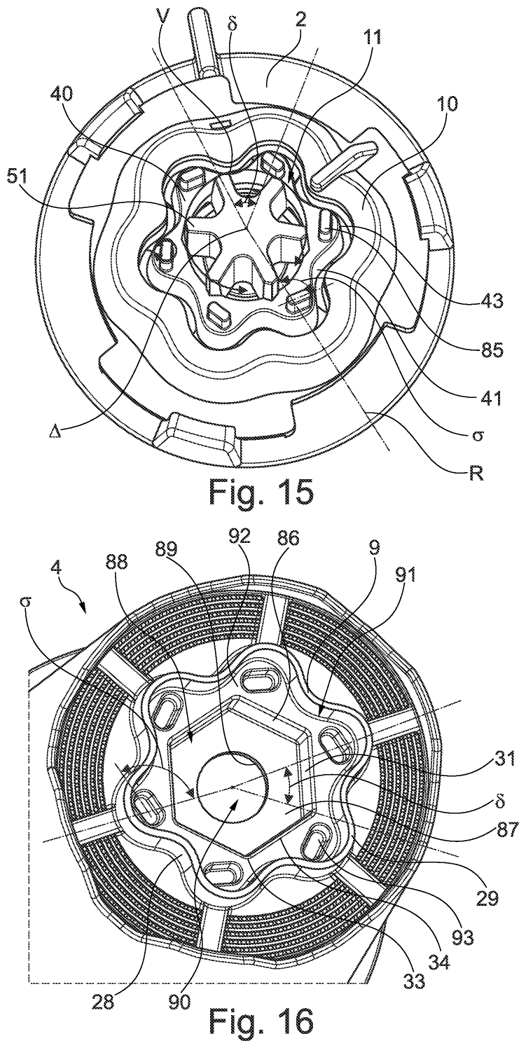

FIG. 16 shows the connector 9 having the filter sealing face 28 of a matching filter cartridge 4. The guide structure 31, like the previously described embodiment, has a polygonal ring 34 which in this embodiment however in the axial direction runs with flat side walls 86 without the internal curvatures 35 and the guide grooves 32 formed as a result. The oblique transition face 87 in this embodiment, conjointly with the side walls 86, forms a transition portion 88 to an inner portion 89 of an outlet line 90 of the filter cartridge 4, and connects the latter to a first portion 88 of the outlet line 90 which during operation is disposed upstream of said inner portion 89.

The connector 9 on the inside represents an exit portion 91 of the outlet line 90, and by way of a connection wall 92 is connected to the transition portion 88, or the polygonal ring 34 of the guide structure, respectively.

Affixed in this connection wall 91 are axial depressions 93. The depressions 93 in terms of their angular position in relation to the edges 33 of the polygonal ring (cf. angle [symbol] ) are adapted to the angular position of the projections 85 of the centering element in relation to the guide ribs 51, as a result of which the key/lock function is implemented. The depressions 93 have an elongate shape corresponding to that of the projections 85, and in terms of the angular alignment (cf. angle δ) are adapted to the angular alignment of the projections 85 of the centering element in relation to the radius R emanating from the axis A, as a result of which the additional coding function described is implemented.

Although the present invention has been described with reference to preferred embodiments, workers skilled in the art will recognize that changes may be made in form and detail without departing from the spirit and scope of the invention.

### List of Reference Signs

1 Water tank
2 Tank bottom
3 Water tank side wall
4 Filter cartridge
5 Filter housing
6 Tank connection element
7 Filter connection
8 Interior
9 Filter connector
10 Fastening ring
11 Centering element
12 Depression
13 Tank valve body
14 Seal
15 Pin
16 Elastomer seal
17 Wasser tank seal/annular seal
18 Tank sealing face
19 Concavity
20 Convexity
21 Connection region
22 Filter cartridge
23 Filter connector /inner ring
24 Outer ring
25 Projection
26 Recess
27 Inlet screen
28 Filter sealing face/external face
29 Convexity
30 Concavity
31 Guide structure
32 Guide groove
33 Edge
34 Polygonal ring
35 Internal curvature
36 Wall
37 Filter housing
38 Metering opening
39 Bottom plate
40 Centering plinth
41 External face
42 Concavity
43 Convexity
44 Tooth
45 Gradation
46 Elevation
47 Gap
48 Passage opening
49 Bottom vent
50 Cavity
51 Guide rib
52 Guide ramp
53 Latching projection
54 Bottom rib
55 Bottom portion
56 Sealing bead
57 Annular seal
58 Sealing groove
59 Inner ring
60 Outer ring
61 Bypass opening
62 Annular gap
63 Bypass opening
64 Sealing lip
65 Sealing face
66 Internal side
67 Restoring spring
68 Second filter fixing face/internal face
69 Wall
70 Annular spring
71 Wand external side
72 Wand internal side
73 Center line
74 Outer envelope circle
75 Inner envelope circle
76 Convex circle segment
77 Concave circle segment
78 Center
79 Center
80 Center circle line
81 Circle segment
82 Segment center
83 Turning point
84 Tank passage opening
85 Axial projection
86 Side wall
87 Oblique transition face
88 Transition portion
89 Inner portion
90 Outlet line
91 Exit portion
92 Connection wall
93 Depression
A Axis
W Wall thickness
S Segment radius
P1 Flow direction
P2 Flow direction
R Radius
V Twist

1. A filter cartridge for the use in the interior of a water tank of a domestic appliance having a filter housing of which the wall separates in a watertight manner a housing internal side from a housing external side, wherein a filter inlet opening which in the operating position of the filter cartridge is disposed on the lower end region of the latter and is open in relation to the external environment of the filter housing is provided, wherein provided downstream of the filter inlet opening in terms of the flow direction of water during operation, in the interior of the filter housing, is a device for water conduction which comprises at least one filter chamber having at least one filter medium and terminates in a filter outlet line for suctioning water from the filter cartridge; and
wherein a filter connector having an annular filter sealing face for connecting the filter cartridge in a water tank is provided,
wherein
provided within the filter sealing face is a guide structure, disposed separately from this filter sealing face, for receiving a centering element for centering the filter cartridge.

2. The filter cartridge as claimed in claim 1, wherein the filter-proximal guide structure forms a portion of an outlet line of the filter cartridge, which in terms of the flow direction during operation is disposed downstream at the end of the filter section.

3. The filter cartridge as claimed in claim 1, wherein the portion of the outlet line that has the guide structure, has a larger cross section than an inner portion of the outlet line that lies upstream in terms of the flow direction during operation.

4. The filter cartridge as claimed in claim 1, wherein the filter connector that has the filter sealing face comprises an exit portion of the outlet line of the filter cartridge, the portion that has the guide structure forms a transition portion of the outlet line, and the exit portion has a larger cross section than the transition portion.

5. The filter cartridge as claimed in claim 1, wherein the filter-proximal guide structure in the transition portion to the inner portion of the outlet line has one or a plurality of oblique transition faces which are disposed obliquely in relation to the assembling direction of the filter cartridge.

6. The filter cartridge as claimed in claim 1, wherein the inner portion and the exit portion of the outlet line are disposed so as to be coaxial with a central axis of the outlet line, and the transition portion by means of one or a plurality of transition faces that run obliquely from the exit portion to the inner portion and radially from the outside to the inside and axially from the bottom up in terms of the operation position of the filter cartridge, connects the exit portion to the inner portion.

7. The filter cartridge as claimed in claim 1, wherein the filter-proximal guide structure is configured and disposed so as to be coaxial with the filter sealing face.

8. The filter cartridge as claimed in claim 1, wherein the filter-proximal guide structure has one or a plurality of guide faces which run parallel to the central axis, and/or one or a plurality of transition faces which are disposed obliquely thereto.

9. The filter cartridge as claimed in claim 1, wherein holding or latching elements are affixed in the filter-proximal guide structure.

10. The filter cartridge as claimed in claim 1, wherein the exit portion of the outlet line of the filter cartridge by way of a connection wall that runs transversely to the central axis is connected to the transition portion, wherein the connection wall has axial depressions and/or axial projections.

11. The filter cartridge as claimed in claim 1, characterized in that the axial depressions and/or axial projections are disposed in the region of radial convexities of the filter sealing face.

12. The filter cartridge as claimed in claim 1, characterized in that the axial depressions and/or axial projections have an elongate shape with an angular alignment in relation to a radius emanating from the central axis.

13. The filter cartridge as claimed in claim 1, wherein the axial depressions and/or axial projections as a result of their position and/or angular alignment for coding the filter cartridge are in an angular relationship with the guide structure

14. The filter cartridge as claimed in claim 1, wherein filter-proximal guide structure has one or a plurality of guide grooves for receiving tank-proximal structures.

15. The filter cartridge as claimed in claim 1, wherein one or a plurality of oblique transition faces of the filter-proximal guide structure are disposed in one or a plurality of guide grooves for receiving tank-proximal structures.

16. A water tank for a domestic appliance having a filter cartridge as claimed in claim 1, and a tank bottom, wherein an annular tank sealing face, which encloses a tank passage opening for the flow of water from the filter cartridge through the wall of the tank bottom to the domestic appliance, for tightly connecting the filter cartridge is provided on the tank bottom, wherein a centering element, which within the tank sealing face projects from the tank bottom in the direction of the assembled position of the filter cartridge, for plugging into the filter-proximal guide structure of the filter cartridge is provided.

17. The water tank as claimed in claim 16, wherein the centering element has at least one water passage for water from the filter cartridge through the filter-proximal guide structure of an attached filter cartridge to the tank passage opening.

18. The water tank as claimed in claim 16, wherein the tank sealing face is configured and disposed separately from the centering element.

19. The water tank as claimed in claim 16, wherein the centering element comprises guide ribs which extend in the flow direction of the water during operation, the intermediate space of said guide ribs forming a water passage.

20. The water tank as claimed in claim 16, wherein the centering element has a centering plinth as a plinth element from which the guide ribs extend upward in terms of the operating position of the water tank.

21. The water tank as claimed in claim 16, wherein axial projections and/or axial depressions for attaching or inserting the axial depressions and/or axial projections of the filter cartridge are affixed to the centering plinth.

22. The water tank as claimed in claim 16, wherein the axial projections and/or axial depressions on the centering plinth are disposed in the region of the radial convexities of the external face.

23. The water tank as claimed in claim 16, wherein the centering element comprises ribs disposed in a star-shaped manner.

24. The water tank as claimed in claim 16, wherein at least one rib has an upper oblique guide face and/or at least one guide face running parallel to the central axis for guiding the filter-proximal guide structure when assembling the filter cartridge.

25. The water tank as claimed in claim 16, wherein at least one rib has an upper oblique guide face for interacting in a guiding manner with at least one oblique guide face of at least one guide groove of the filter-proximal guide structure when assembling the filter cartridge.

26. The water tank as claimed in claim 16, wherein holding or latching elements are affixed to the centering element.

27. The water tank as claimed in claim 16, wherein a tank valve which has a plug element that is movable by a tank valve body and is able to be inserted through a passage of the centering element is provided.

28. The water tank as claimed in claim 16, wherein the centering element is affixed to a fastening ring for the tank bottom.
